(19) United States
(12) Patent Application Publication
(10) Pub. No.: US 2013/0238731 A1
(43) Pub. Date: Sep. 12, 2013

(54) INFORMATION PROCESSING SYSTEM, METHOD FOR CONTROLLING THE SAME, INFORMATION PROCESSING APPARATUS, AND STORAGE MEDIUM

(71) Applicant: CANON KABUSHIKI KAISHA, Tokyo (JP)

(72) Inventor: Hirochika Sato, Kawasaki-shi (JP)

(73) Assignee: CANON KABUSHIKI KAISHA, Tokyo (JP)

(21) Appl. No.: 13/790,339

(22) Filed: Mar. 8, 2013

(30) Foreign Application Priority Data
Mar. 12, 2012 (JP) 2012-055001

(51) Int. Cl. H04L 12/58

(52) U.S. Cl. CPC H04L 51/16
USPC 709/206

(57) ABSTRACT

An information processing system includes a handwritten comment acquisition unit configured to acquire, as an image object, handwritten comment information for a print product obtained by printing an original image, a selection unit configured to select the handwritten comment information based on a user's instruction, an electronic comment acquisition unit configured to acquire electronic comment information for the handwritten comment information selected by the selection unit, a thread management unit configured to manage, as thread information, the handwritten comment information selected by the selection unit and the electronic comment information acquired by the electronic comment acquisition unit in association with each other, and a display unit configured to superimpose the thread information managed by the thread management unit on the original image to display the thread information in a thread shape.

### BACKGROUND OF THE INVENTION

1. Field of the Invention

The present invention relates to an information processing system, a method for controlling the same, an information processing apparatus, and a storage medium.

2. Description of the Related Art

There is an electronic bulletin board system (hereinafter, simply referred to as an electronic bulletin board) for controlling registration or reading of information carried out by many users. The electronic bulletin board is used for widely carrying out transmission of various pieces of information communication between users. In such an electronic bulletin board, the user transmits information to be registered in the electronic bulletin board to a server connected to a network via an information terminal. The information received by the server is registered in the electronic bulletin board managed by the server, and the information terminal reads the registered information to display it on its display unit. Japanese Patent Application Laid-Open No. 2001-101114 discuses a technology of processing not only comments as text information but also images such as photos in an electronic bulletin board.

To register information handwritten in a paper document in the electronic bulletin board discussed in Japanese Patent Application Laid-Open No. 2001-101114, the user captures an image of the paper document including the handwritten information, and then registers the captured image in the electronic bulletin board. In this case, when the user additionally inputs information (electronic comment) via the information terminal trying to add a comment to the handwritten information (handwritten comment), the electronic comment is added to the captured image. Then, in the case of referring to the electronic comment and the captured image afterwards, it is difficult to determine which part of the captured image the additionally input electronic comment corresponds to. In other words, since information about the part handwritten in the paper document by the user is not processed as one object, the input electronic comment cannot be managed in association with not the captured image but the information about the handwritten part (handwritten comment). This creates a difficulty of determining a relationship between comments in subsequent reference to the comments.

### SUMMARY OF THE INVENTION

According to an aspect of the present invention, an information processing system includes a handwritten comment acquisition unit configured to acquire, as an image object, handwritten comment information for a print product obtained by printing an original image, a selection unit configured to select the handwritten comment information based on a user's instruction, an electronic comment acquisition unit configured to acquire electronic comment information for the handwritten comment information selected by the selection unit, a thread management unit configured to manage, as thread information, the handwritten comment information selected by the selection unit and the electronic comment information acquired by the electronic comment acquisition unit in association with each other, and a display unit configured to superimpose the thread information managed by the thread management unit on the original image to display the thread information in a thread shape.

According to the exemplary embodiment of the present invention, the handwritten information and the information input from the information terminal can be referred to en bloc in association with each other.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an overall configuration of an information processing system.

FIG. 2 illustrates a configuration of an electronic pen.

FIG. 3 illustrates a configuration of a communication terminal.

FIG. 4 illustrates a configuration of a server.

FIG. 5 illustrates a configuration of an information terminal.

FIG. 6 illustrates a paper document.

FIG. 7 is a flowchart illustrating transmission processing of locus information of the electronic pen.

FIG. 8 is a flowchart illustrating calculation processing of coordinates indicating the movement locus of the electronic pen in a communication terminal.

FIG. 9 is a flowchart illustrating acquisition processing of handwritten comment locus information in the communication terminal.

FIG. 10 illustrates a paper document.

FIG. 11 illustrates an electronic bulletin board.

FIG. 12 is a flowchart illustrating acquisition processing of handwritten comment information in the server.

FIG. 13 illustrates an electronic bulletin board.

FIG. 14 illustrates an electronic bulletin board.

FIG. 15 illustrates an electronic bulletin board.

FIG. 16 illustrates an electronic bulletin board.

FIG. 17 is a flowchart illustrating input processing of an electronic input form in the information terminal.

FIGS. 18A and 18B illustrate thread information.

FIG. 19 is a flowchart illustrating thread management processing in the server.

FIG. 20 is a flowchart illustrating superimposed display processing in the information terminal.

FIG. 21 is a flowchart illustrating superimposed display processing in the server.

FIG. 22 illustrates a search screen.

FIG. 23 illustrates a search result screen.

FIG. 24 illustrates a reference file path input screen.

FIGS. 25A and 25B illustrate thread displays.

### DESCRIPTION OF THE EMBODIMENTS

Various exemplary embodiments, features, and aspects of the invention will be described in detail below with reference to the drawings.

(System Configuration)

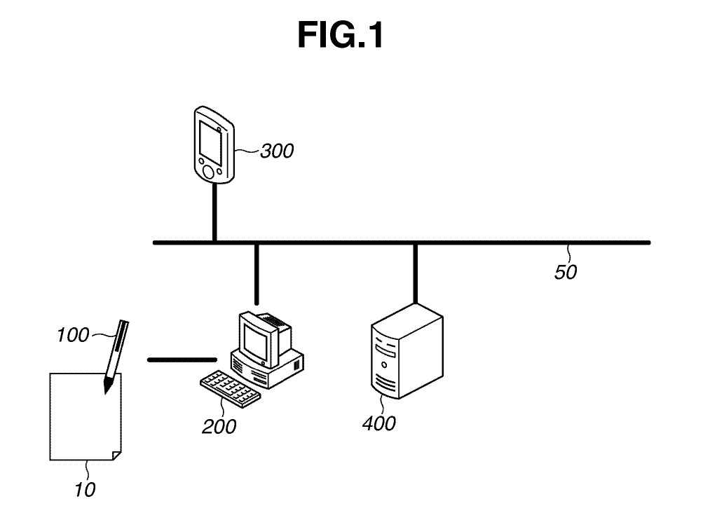

FIG. 1 illustrates an overall configuration of an information processing system.

In FIG. 1, a paper document (print product) 10 in which original data (original image) has been printed can be distributed to a plurality of users or presented in a bulletin board. An electronic pen 100 is connected one to one to a communication terminal 200 by wireless communication. The communication terminal 200, a server 400, and an information terminal 300 are interconnected via a network 50 such as a local area network (LAN). The electronic pen 100, which is a device for adding characters or graphics to the paper document 10 by handwriting, transmits locus information (electronic pen locus information) of the electronic pen 100.

The communication terminal 200 extracts, from the received electronic pen locus information, the handwritten locus information (handwritten comment locus information) of the electronic pen 100 to transmit it to the server 400.

The server 400 generates handwritten comment information based in the received handwritten comment locus information. The server 400 receives electronic comment information and reference file information from the information terminal 300. In the present exemplary embodiment, the original data, the handwritten comment information, the electronic comment information, and the reference file information are collectively referred to as electronic bulletin board information, and stored in the server 400 to be managed.

The information terminal 300 displays the electronic bulletin board information managed by the sever 400 on its display unit. The information terminal 300 transmits the electronic comment information or the reference file information input by the user as the electronic bulletin board information displayed on the display unit to the server 400. The information terminal 300, which includes an image capturing unit such as a camera, captures an image of the paper document 10 by the image capturing unit, and displays the image of the paper document 10 on the display unit. In this case, the information terminal 300 can superimpose the electronic bulletin board information on the captured image displayed on the display unit to display it. When the information terminal 300 does not include any image capturing unit, an image capturing unit such as a camera externally connected by a universal serial bus (USB) cable can be used.

(Electronic Pen)

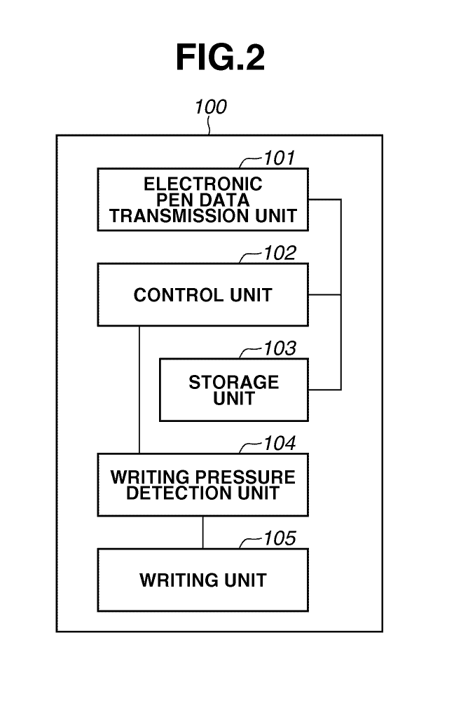

FIG. 2 illustrates a configuration of the electronic pen 100 according to the present exemplary embodiment.

A writing unit 105 writes characters or graphics in the paper document 10 to be visible by using ink in an ink cartridge. A writing pressure detection unit 104, which is realized by a writing pressure sensor, detects writing pressure applied to the pen during writing in the paper document 10. An electronic pen data transmission unit 101, which is realized by an infrared transmission device for transmitting infrared rays or an ultrasonic transmission device for transmitting an ultrasonic wave, transmits electronic pen locus information to the communication terminal 200. A storage unit 103, which is realized by a memory such as a random access memory (RAM) or a read-only memory (ROM), stores temporary data needed by a control unit 102. The control unit 102 controls the electronic pen 10 overall, which is achieved through execution of a program code stored in the storage unit 103 by a central processing unit (CPU). The control unit 102 executes control to transmit, by infrared rays, a pressure start signal indicating a pressure start to the electronic pen data transmission unit 101 when the writing pressure detection unit 104 detects the pressure start. The control unit 102 also executes control to transmit, by infrared rays, a pressure end signal indicating a pressure end to the electronic pen data transmission unit 101 when the writing pressure detection unit 104 detects the pressure end. The control unit 102 further controls the electronic pen data transmission unit 101 to transmit ultrasonic waves at a fixed period within time from the pressure start to the pressure end. An ultrasonic signal transmitted from the electronic pen data transmission unit 101 indicates position information of the electronic pen as described below.

(Communication Terminal)

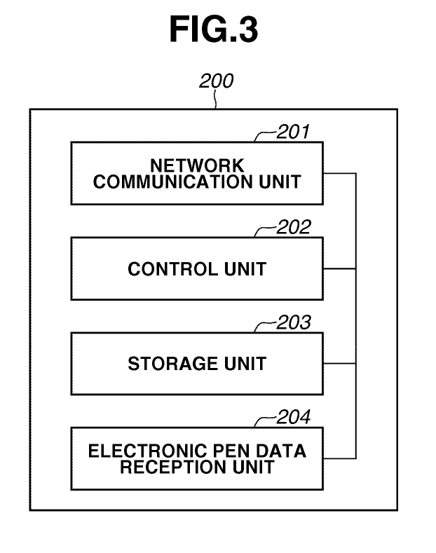

FIG. 3 illustrates a configuration of the communication terminal 200 according to the present exemplary embodiment.

An electronic pen data reception unit 204 is realized by a receiver including one infrared reception sensor and two ultrasonic reception sensors. The electronic pen data reception unit 204 receives the electronic pen locus information including the infrared signal and the ultrasonic signal transmitted from the electronic pen data transmission unit 101. A network communication unit 201, which is realized by a LAN interface (I/F), transmits handwritten comment locus information to the server 400 via the network 50. A storage unit 203, which is realized by a memory such as a ROM, a RAM, or a hard disk drive (HDD), stores temporary data needed by a control unit 202, the electronic pen locus information, or the handwritten comment locus information. The control unit 202 controls the units overall, which is achieved through execution of a program code stored in the storage unit 203 by a CPU. The control unit 202 executes control to store the electronic pen locus information received by the electronic pen data reception unit 204 in the storage unit 203. The control unit 202 controls the network communication unit 201 to extract the handwritten comment locus information from the electronic pen locus information read from the storage unit 203 to transmit it to the server 400.

(Server)

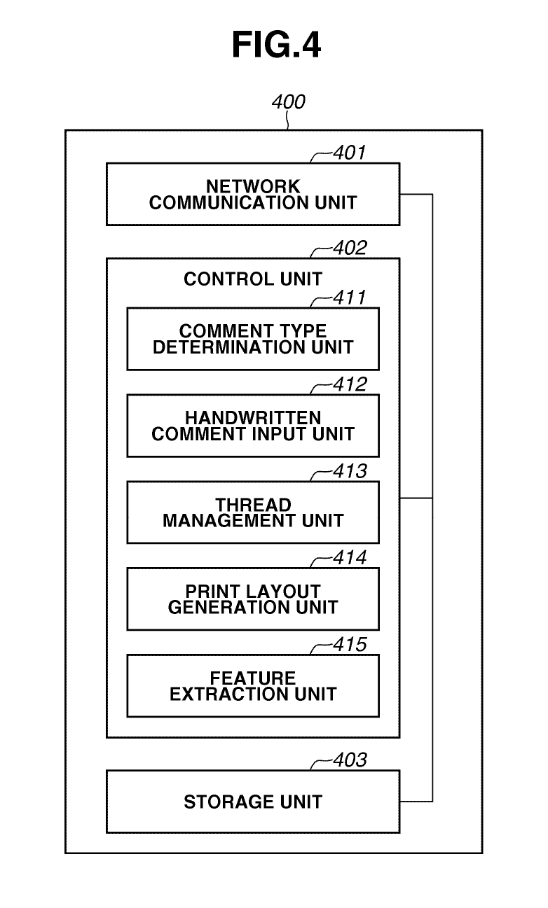

FIG. 4 illustrates a configuration of the server 400.

A network communication I/F 401, which is realized by a LAN/IF, transfers various data with the communication terminal 200 and the information terminal 300 via the network 50. A storage unit 403, which is realized by a memory such as a RAM, a ROM, or a HDD, stores the electronic bulletin board information in the present exemplary embodiment. The network communication I/F 401 receives comment information to store it in the storage unit 403. The electronic bulletin board information includes original data, thread information, or temporary stored data similar in content to an image printed in a paper surface.

A control unit 402 controls the units overall, which is achieved through execution of a program code stored in the storage unit 403 by a CPU.

Further, the control unit 402 includes a comment type determination unit 411, a handwritten comment input unit 412, a thread management unit 413, a print layout unit 414, and a feature extraction unit 415.

The comment type determination unit 411 determines which of the handwritten comment information, the electronic comment information and the reference file information the comment information received from the network communication unit 401 belongs to. In the present exemplary embodiment, communication between the server 400 and the information terminal 300 and between the server 400 and the communication terminal 200 is based on HyperText Transfer Protocol (HTTP), and an identifier of a comment type (comment identifier) is also transmitted when the comment information is transferred. By referring to the identifier of the comment type, the comment type of the received comment information is determined.

When the comment type determination unit 411 determines that the received comment information belongs to the comment type of the handwritten comment information, the received comment information is handwritten comment locus information. Accordingly, the handwritten comment input unit 412 draws a bitmapped image (image object) of the handwritten comment locus information to generate handwritten comment information, and stores the handwritten comment information in the storage unit 403. The generated handwritten comment information is managed by the thread management unit 413. The network communication unit 401 functions to receive information handwritten in the paper document 10 from the communication terminal. The handwritten comment input unit 412 functions to acquire the information handwritten in the paper document 10 as an image object.

When the comment type determination unit 411 determines that the received comment information belongs to the comment type of the electronic comment information or the reference file information, the received comment information is electronic comment information or reference file information. The electronic comment information or the reference file information is managed by the thread management unit 413.

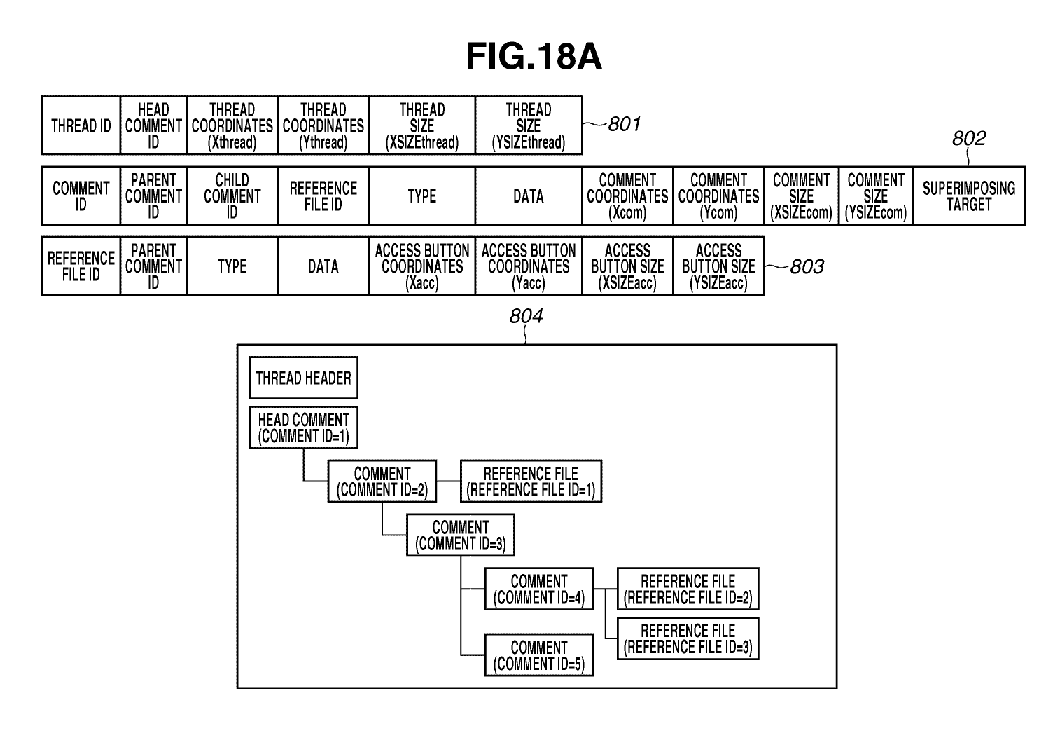

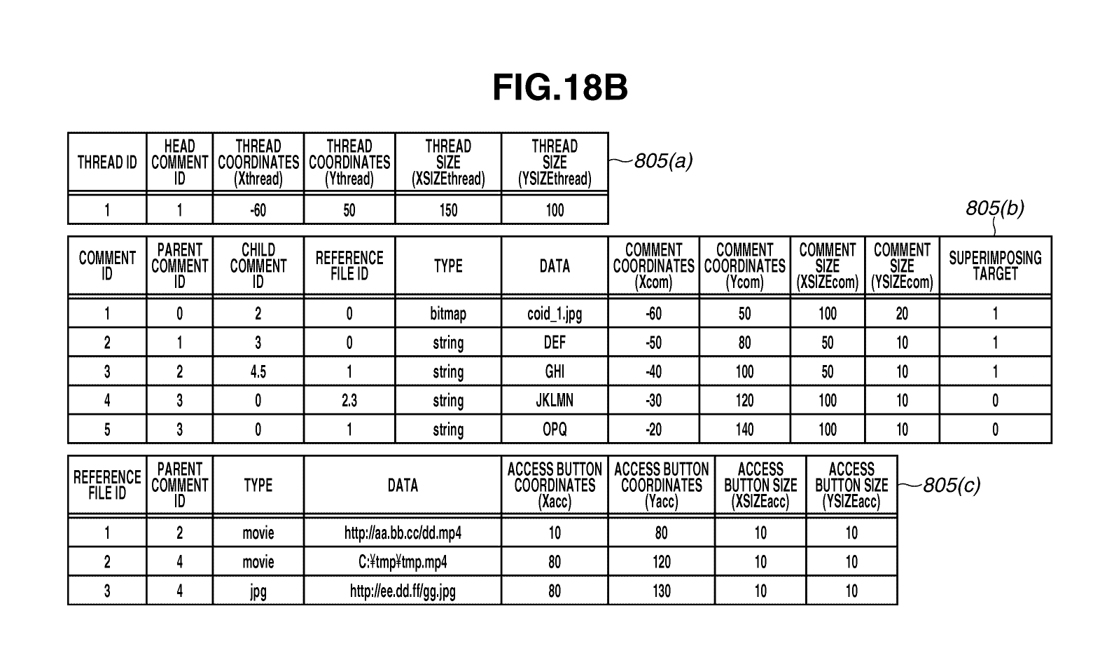

The thread management unit 413 generates thread information, in which the handwritten comment information, the electronic comment information, and the reference file information are associated with one another, to store it in the storage unit 403. As described below referring to FIGS. 18A and 18B, the thread information is a data table indicating a parent relationship among the handwritten comment information, the electronic comment information and the reference file information or positional information when each information is input. The thread management unit 413 manages each of the handwritten comment information, the electronic comment information and the reference file information as thread information in association by updating the thread information according to addition of the handwritten comment information, the electronic comment information and the reference file information.

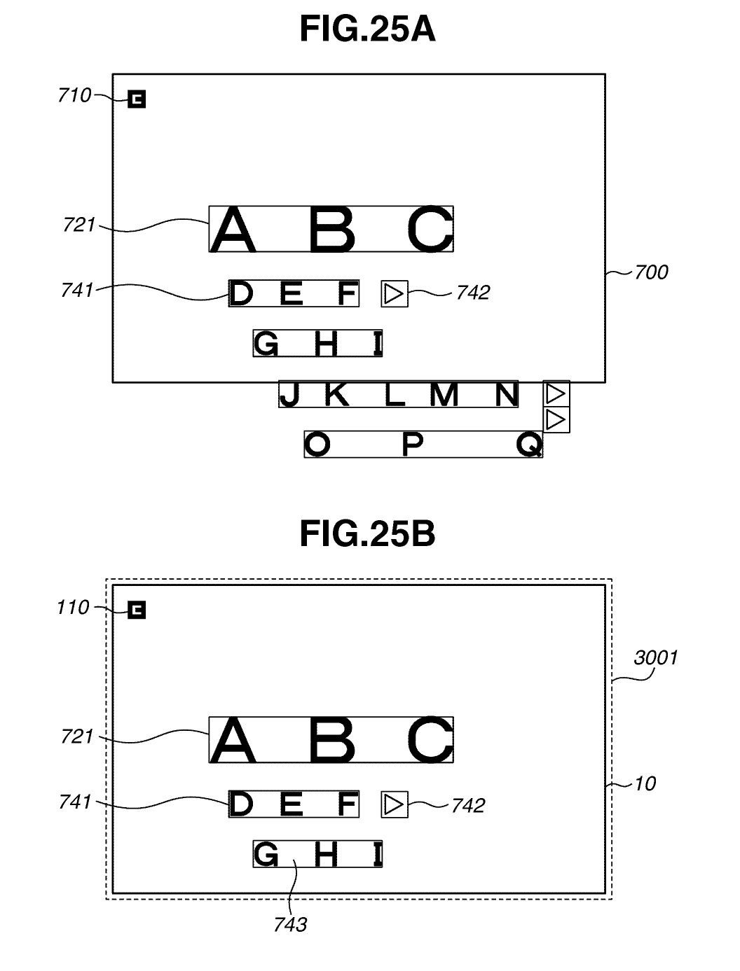

The print layout unit 414 generates a print layout of electronic bulletin board information when it receives a printing request of the electronic bulletin board information from the information terminal 300. In the present exemplary embodiment, the print layout unit 414 targets, for printing, an electronic bulletin board display result (e.g., FIG. 25A) where the thread information stored in the storage unit 403 is superimposed on original data 700 described below to be displayed. The printing is achieved by using a printer driver installed in the information terminal 300 to issue printing instruction to a printer (not illustrated) connected to the information terminal 300. Specifically, the information terminal 300 includes a printing instruction unit for instructing printing of the electronic bulletin board information. The electronic bulletin board information is printed by the printing instruction unit.

The feature extraction unit 415 extracts a feature pattern such as a text pattern or a graphic pattern from the original data 700. In the present exemplary embodiment, the feature extraction unit 415 extracts a pattern 710 from the original data 700.

(Information Terminal)

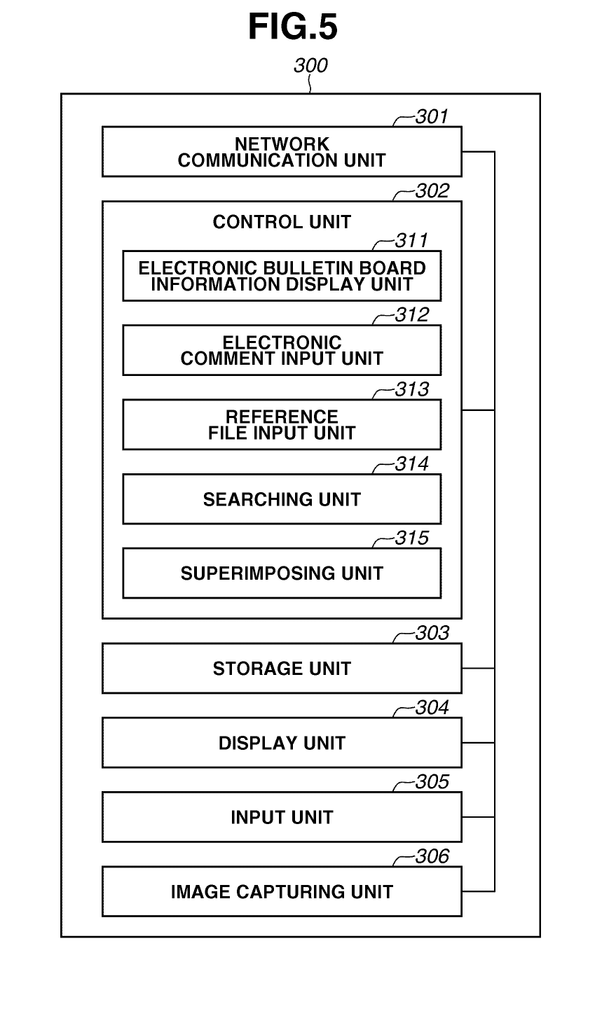

FIG. 5 illustrates a configuration of the information terminal 300.

A network communication unit 301, which is realized by a LAN/IF, transfers various data with the sever 400 via the network 50. A storage unit 303, which is realized by a memory such as a RAM, a ROM, or a HDD, stores the temporary stored data used by a control unit 302 in the present exemplary embodiment.

A display unit 304, which is realized by a display (including a touch panel), displays the electronic bulletin board information or an image captured by an image capturing unit 306. An input unit 305, which is realized by an input device such as a touch pane, a mouse or a keyboard, receives an input operation from the user. The image capturing unit 306, which is realized by a camera, acquires the captured image of the paper document.

A control unit 302 controls the units overall, which is achieved through execution of a program code stored in the storage unit 303 by a CPU.

Further, the control unit 302 includes an electronic bulletin board information display unit 311, an electronic comment input unit 312, a reference file input unit 313, a searching unit 314, and a superimposing unit 315.

The electronic bulletin board information display unit 311 displays the electronic bulletin board information acquired from the server 400 on the display unit 304. The electronic bulletin board information display unit 311 displays an electronic input form for receiving an electronic comment input from the user.

The electronic comment input unit 312 acquires a character string (electronic comment) input to the electronic input form from the user by using the input unit 305, and transmits it as electronic comment information to the server 400. The reference file input unit 313 acquires a path (reference file path) to a reference file input to the electronic input form from the user by using the input unit 305, and transmits it as reference file information to the server 400. The searching unit 314 carries out searching processing based on a search key input to the electronic input form from the user by using the input unit 305.

The superimposing unit 315 displays the image of the paper document captured by the image capturing unit 306 on the display unit 304, and superimposes the electronic bulletin board information on the image of the paper document to display it.

(Handwritten Comment Input)

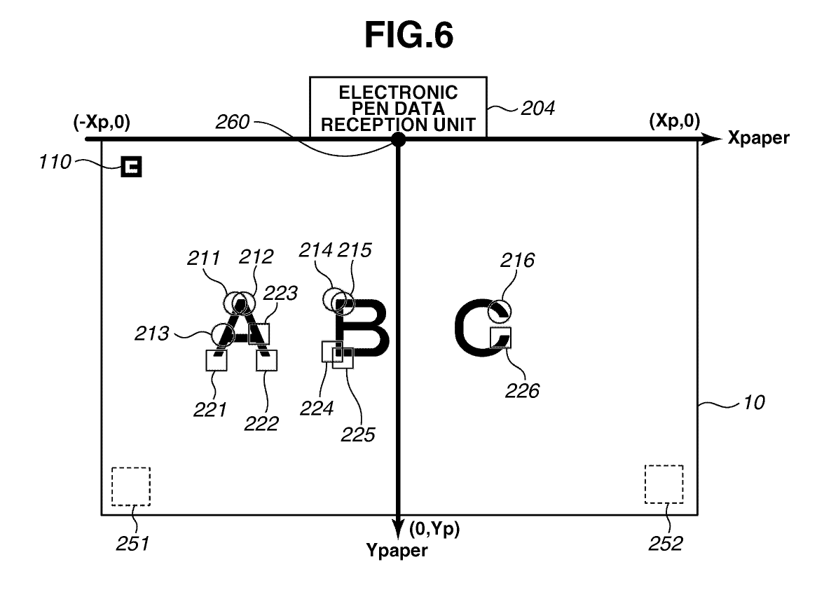

FIG. 6 illustrates a paper surface of the paper document 10 according to the present exemplary embodiment. In the paper document 10, a feature pattern used for carrying out superimposed display processing of the thread information described below is printed as a pattern 110. However, the feature pattern can be visible or invisible to people.

In the present exemplary embodiment, the paper surface is represented by a coordinate system (Xpaper, Ypaper), and a receiver realizing the electronic pen data reception unit 204 is disposed at the upper center of the paper document 10 to set a paper surface original point 260 (0,0). This is for matching with the electronic bulletin board where the upper center of the original data 700 described below is a coordinate original point. The paper document 10 is at positions of (−XP, 0), (Xp, 0), (−Xp, Yp), and (Xp, Yp) in the coordinate system of the paper surface.

At the time of starting writing of a handwritten comment in the paper document 10 by the electronic pen 100, the user checks a handwritten comment start area 251. Then, the user writes “ABC” that is a handwritten comment.

The “ABC” includes pressure start points 211 to 216 detected by the writing pressure detection unit 104. The “ABC” includes pressure end points 221 to 226 detected by the writing pressure detection unit 104.

The user checks a handwritten comment end area 252 after the end of handwritten comment writing.

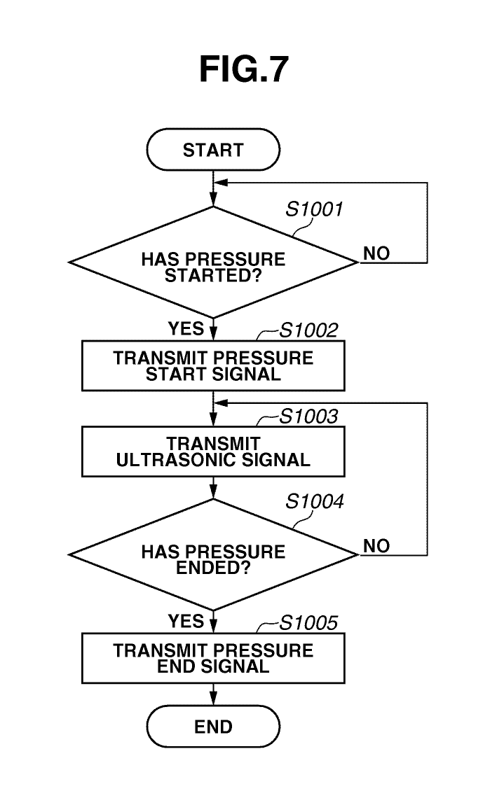

FIG. 7 is a flowchart illustrating a flow of transmitting a series of pieces of electronic pen locus information to the communication terminal 200 by the electronic pen 100.

In step S1001, the control unit 102 of the electronic pen 100 determines whether the writing pressure detection unit 104 has detected a pressure start. When it is determined that the pressure start has been detected (YES in step S1001), the processing proceeds to step S1002, and the control unit 102 controls the electronic pen data transmission unit 101 to transmit a pressure start signal by infrared rays. Then, in step S1003, the control unit 102 transmits an ultrasonic signal. In step S1004, the control unit 102 continuously transmits ultrasonic signals at a fixed period until the writing pressure detection unit 104 detects a pressure end. After the detection of the pressure end, in step S1005, the control unit 102 controls the electronic pen data transmission unit 101 to transmit a pressure end signal by infrared rays. The ultrasonic signals from the transmission of the pressure start signal to the transmission of the pressure end signal are a series of pieces of electronic pen locus information.

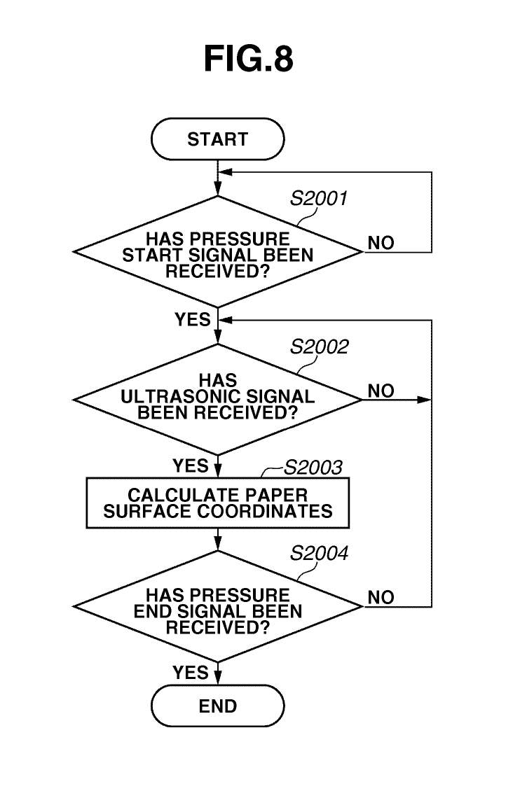

FIG. 8 is a flowchart illustrating the flow of receiving the series of pieces of electronic pen locus information from the electronic pen 100 and calculating coordinates (paper surface coordinates) indicating the movement locus of the electronic pen by the communication terminal 200.

In step S2001, the control unit 202 determines whether the electronic pen data reception unit 204 has received an infrared pressure start signal. When it is determined that the pressure start signal has been received (YES in step S2001), the processing proceeds to step S2002.

Then, in step S2002, the control unit 202 determines whether the electronic pen data reception unit 204 has received an ultrasonic signal. When it is determined that the ultrasonic signal has not been received (NO in step S2002), the processing proceeds to step S2004.

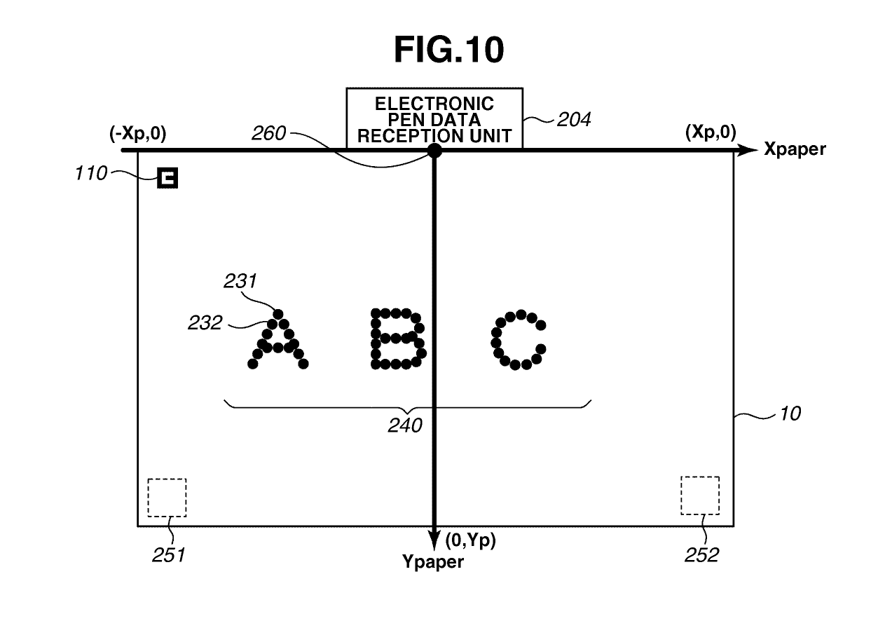

When it is determined that the ultrasonic signal has been received (YES in step S2002), in step S2003, the control unit 202 calculates a difference between reception time of the ultrasonic signals received by two ultrasonic reception sensors, and paper surface coordinates of the electronic pen from a distance between the two ultrasonic sensors. The paper surface coordinates will be described below referring to FIG. 10.

Then, in step S2004, the control unit 202 determines whether the electronic pen data reception unit 204 has received an infrared pressure end signal. When it is determined that the pressure end signal has not been received (NO in step S2004), the processing returns to step S2002. When it is determined that the pressure end signal has been received (YES in step S2004), the control unit 202 ends the acquisition of the series of pieces of pen locus information from the pressure start to the pressure end. Specifically, the control unit 202 sequentially calculates, by executing the processing flow illustrated in FIG. 8, information of the paper surface coordinates indicating the movement locus of the electronic pen from the continuously received pieces of electronic pen locus information. Hereinafter, the information including the information of the paper surface coordinates indicating the movement locus of the electronic pen calculated in step S2003 will be referred to as electronic pen locus information.

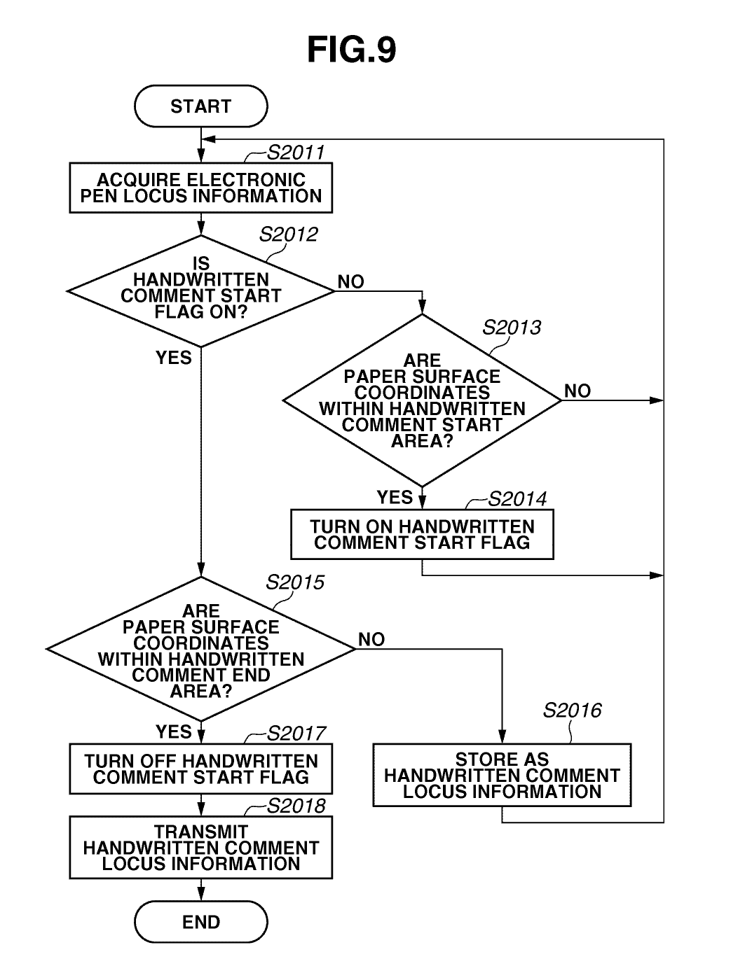

FIG. 9 is a flowchart illustrating processing of setting the handwritten comment “ABC” illustrated in FIG. 6 as handwritten comment locus information in the communication terminal 200. Specifically, the control unit 202 extracts handwritten comment locus information from the series of pieces of electronic pen locus information by executing the processing flow illustrated in FIG. 9.

In step S2011, the control unit 202 acquires the electronic pen locus information including the information about the paper surface coordinates of the electronic pen calculated in the processing flow of FIG. 8.

Then, in step S2012, the control unit 202 determines whether a handwritten comment start flag is ON. The handwritten comment start flag stored in the storage unit 203 has its initial value set to OFF.

When it is determined that the handwritten comment start flag is OFF (NO in step S2012), in step S2013, the control unit 202 determines whether the paper surface coordinates of the electronic pen indicated by the pen locus information are within the handwritten comment start area 251. When it is determined that the paper surface coordinates of the electronic pen are not within the handwritten comment start area 251 (NO in step S2013), the processing returns to step S2011. When it is determined that the paper surface coordinates of the electronic pen are within the handwritten comment start area 251 (YES in step S2013), in step S2014, the control unit 202 turns ON the handwritten comment start flag, and the processing returns to step S2011.

When it is determined that the handwritten comment start flag is ON (YES in step S2012), in step S2015, the control unit 202 determines whether the paper surface coordinates of the electronic pen indicated by the electronic pen locus information are within the handwritten comment end area 252. When it is determined that the paper surface coordinates of the electronic pen are not within the handwritten comment end area 252 (NO in step S2015), in step S2016, the control unit 202 stores the electronic pen locus information as a part of the handwritten comment locus information in the storage unit 203, and the processing returns to step S2011. When it is determined that the paper surface coordinates of the electronic pen are within the handwritten comment end area 252 (YES in step S2015), in step S2017, the control unit 202 turns OFF the handwritten comment start flag. In step S2018, the control unit 202 transmits the series of electronic pen locus information group from the handwritten comment start to the end as one piece of handwritten comment locus information (e.g., “ABC”) to the server 400. In this case, the control unit 202 includes a handwritten comment identifier indicating that the handwritten comment locus information belongs to a handwritten comment information type in the handwritten comment locus information to transmit it.

FIG. 10 illustrates handwritten comment locus information that is a result of the paper surface coordinate calculation illustrated in FIG. 6. Coordinates 231 and 232 are examples acquired as a result of the paper surface coordinate calculation. A series of pieces of handwritten comment locus information 240 acquired as a result of sequentially calculating paper surface coordinates at the pressure end points 221 to 226 respectively corresponding to the pressure start points 211 to 216 is handwritten comment locus information “ABC”.

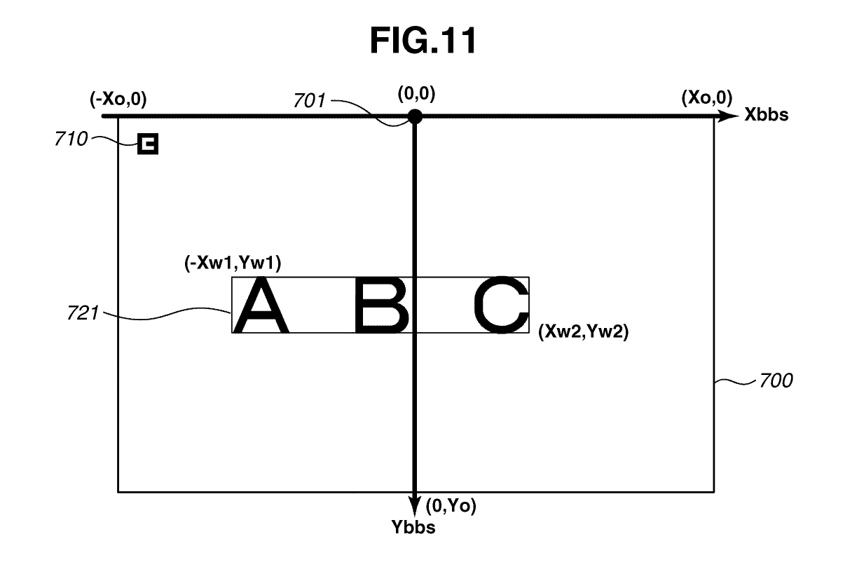

FIG. 11 illustrates the original data 700 corresponding to the paper document 19 in the present exemplary embodiment. The storage unit 403 stores the original data 700. In the present exemplary embodiment, the original data 700 is original data of an image printed on the paper document 10. The paper document 10 is printed by executing print processing for the original data 700.

In the present exemplary embodiment, the electronic bulletin board has a coordinate system (Xbbs, Ybbs), and an upper center of the original data 700 is set as an electronic bulletin board original point 701 (0, 0). The electronic bulletin board original point 701 in the original data 700 corresponds to the paper surface original point 260 in the paper document 10. The original data 700 is represented by a rectangular area including four points of (−X0, 0), (X0, 0), (−X0, Y0), and (X0, Y0) in the electronic bulletin board coordinate system.

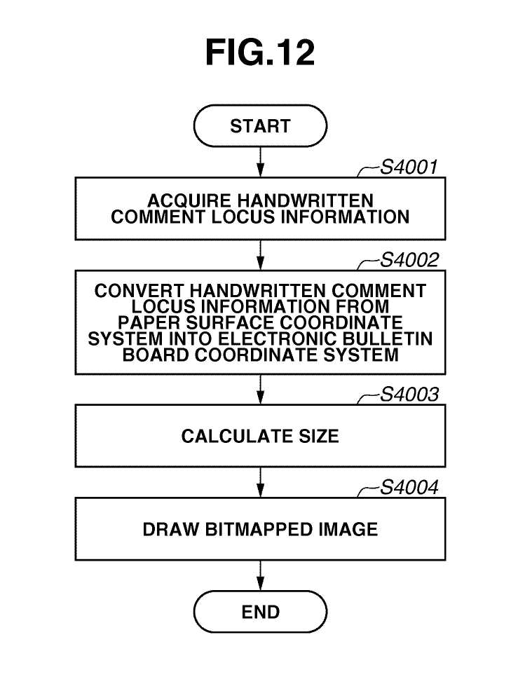

FIG. 12 illustrates a flow of acquiring handwritten comment locus information by drawing a bitmapped image of the handwritten comment locus information by the handwritten comment input unit 412 of the server 400. The processing illustrated in FIG. 12 will be described by taking the example of the handwritten comment locus information 240 “ABC” illustrated in FIG. 6.

The original data 700 has been stored in the storage unit 403.

In step S4001, the handwritten comment input unit 412 receives the handwritten comment locus information 240 and the handwritten comment identifier transmitted from the communication terminal 200 in step S2018. The handwritten comment locus information 240 includes coordinate information of a handwritten comment represented by a paper surface coordinate system (Xpaper, Ypaper).

Then, in step S4002, the handwritten comment input unit 412 converts the coordinate information of the handwritten comment represented by the paper surface coordinate system, which is included in the received handwritten comment locus information 240, into a coordinate system (Xbbs, Ybbs) of the electronic bulletin board. The conversion processing is realized by determining a conversion coefficient beforehand based on a size of the paper document 10 and a size of the original data 700.

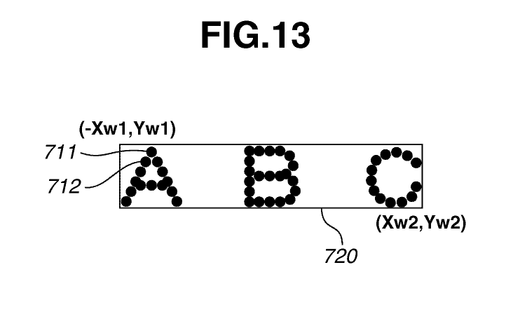

FIG. 13 illustrates an example of a result of converting the handwritten comment locus information 240 into the coordinate system (Xbbs, Ybbs) of the electronic bulletin board, where coordinates 711 or 713 are acquired.

Then, in step S4003, the handwritten comment input unit 412 calculates a minimum rectangle size 720 of rectangle including a coordinate group of the coordinate-converted handwritten comment locus information, thereby acquiring left upper coordinates (−Xw1, Yw1) of the minimum rectangle and right lower coordinates (Xw2, Yw2) of the minimum rectangle.

Then, in step S4004, the handwritten comment input unit 412 draws a color bitmapped image of image data on the coordinates of the coordinate-converted handwritten comment locus information. Then, the handwritten comment input unit 412 generates a handwritten comment 721 of the rectangle size 720 where the bitmapped image of the handwritten comment has been drawn to store it in the storage unit 403. The handwritten comment input unit 412 transmits a file path to the bitmapped image (handwritten comment 721) stored in the storage unit 403, left upper coordinates (−Xw1, Yw1) of the bitmapped image, and the handwritten comment identifier received in step S4001 as handwritten comment information to the thread management unit 413.

(Electronic Input Form)

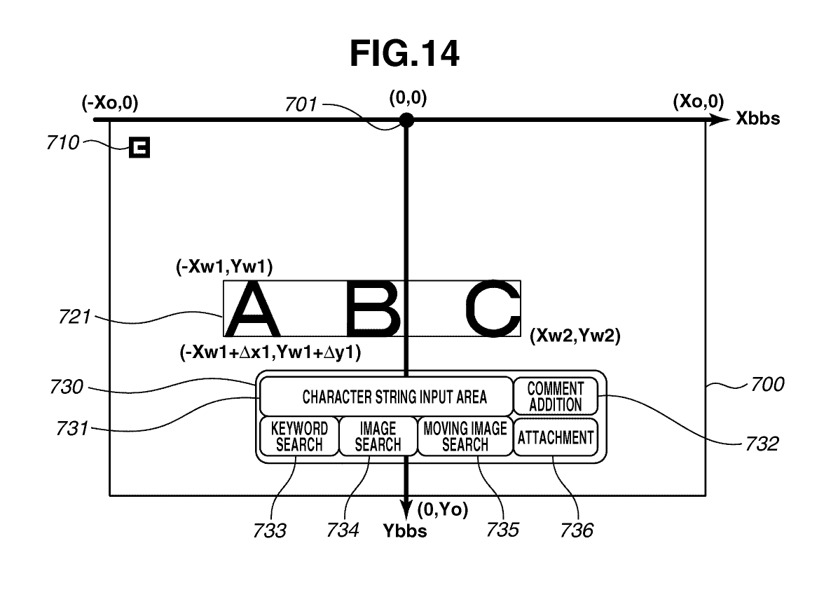

FIG. 14 illustrates the electronic input form.

FIG. 14 illustrates an example where the information terminal 300 receives, from the server 400, the electronic bulletin board information stored in the storage unit 403 of the server 400, and the electronic bulletin board information display unit 311 displays the electronic bulletin board information.

When the user instructs selection of coordinates in an area where the electronic bulletin board information is displayed by the display unit 304 via the input unit 305, the electronic bulletin board information display unit 311 displays an electronic input form 730. FIG. 14 illustrates selection of coordinates in the area of the handwritten comment (bitmapped image) 721. In this case, the electronic bulletin board information display unit 311 displays the electronic input form 730 in an offset position (−Xw1+Δx1, Yw1+Δy1) shifted from the coordinates (display position of the handwritten comment) of the handwritten comment 721 by (Δx1, Δy1). When the user instructs selection of coordinates outside the area of the handwritten comment 721 via the input unit 305, the electronic bulletin board information display unit 311 displays the electronic input form 730 in a position according to the coordinates instructed to be selected.

The electronic input form 730 includes a character string input area 731, an electronic comment addition button 732, a keyword search button 733, an image search button 734, a moving image search button 735, and a reference file attachment button 736. In other words, as described below, the electronic input form 730 includes at least a character string input area for receiving an input of a character string as an electronic comment and a reference file input area for receiving an input of attachment of a reference file.

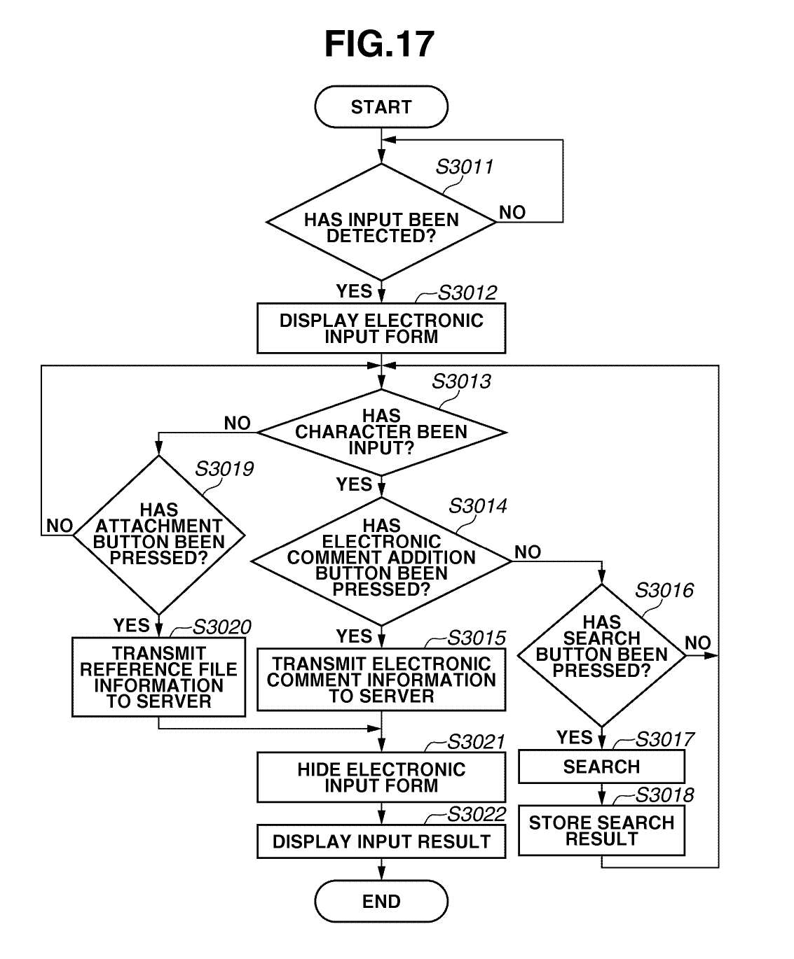

FIG. 17 illustrates a flow of inputting an electronic comment or a reference file in an electronic input form.

In step S3011, the electronic bulletin board information display unit 311 detects whether the user has instructed selection of the coordinates of the area displayed on the display unit 304 via the input unit 305, and determines whether the coordinates instructed to be selected are within the area of the electronic bulletin board information. In step S3012, when it is determined that the coordinates within the area of the electronic bulletin board information have been instructed to be selected (YES in step S3011), the electronic bulletin board information display unit 311 displays the electronic input form 730 in an offset position. When it is determined that the coordinates outside the area of the electronic bulletin board information have been instructed to be selected (NO in step S3011), the electronic bulletin board information display unit 311 displays the electronic input form 730 in a position according to the coordinates instructed to be selected. At this time, the electronic bulletin board information display unit 311 stores coordinates of the position of displaying the electronic input form 730 in the storage unit 303.

Then, in step S3013, the electronic comment input unit 312 determines whether the user has input a character in the character string input area 731 via the input unit 305. When it is determined that the character has been input (YES in step S3013), the electronic comment input unit 312 stores the input character string in the storage unit 303.

In step S3014, the electronic comment input unit 312 determines whether the electronic comment addition button 732 has been pressed.

When it is determined that the electronic comment addition button 732 has been pressed (YES in step S3014), in step S3015, the electronic comment input unit 312 carries out the following processing. The electronic comment input unit 312 transmits, as electronic comment information, the coordinates of the electronic input form 730 stored in the storage unit 303 and the character string input in the character string input area 731 to the server 400. During the transmission of the electronic comment information, the electronic comment input unit 312 includes an electronic comment identifier indicating that the comment information to be transmitted belongs to an electronic comment information type to transmit it. In other words, the server 400 includes a unit for acquiring an electronic comment for the handwritten comment.

When it is determined that the electronic comment addition button 732 has not been pressed (NO in step S3014), in step S3016, the electronic comment input unit 312 determines whether the keyword search button 733, the image search button 734, or the moving image search button 735 has been pressed based on a user's instruction.

When it is determined that the button has been pressed (YES in step S3016), in step S3017, the search unit 314 searches for the character string input in the character string input area 731 by using a web search engine allocated for searching of each type. A known search technology is used for this character string searching, and thus detailed description thereof will be omitted.

At this time, the electronic bulletin board information display unit 311 displays the searching result of the input character string using a search engine that the user has selected by pressing the button on the display unit 304. In this case, in step S3018, the search unit 314 stores the result of search processing of step S3017. The electronic bulletin board information display unit 311 can hide a search engine screen by pressing a hide button on the search engine screen.

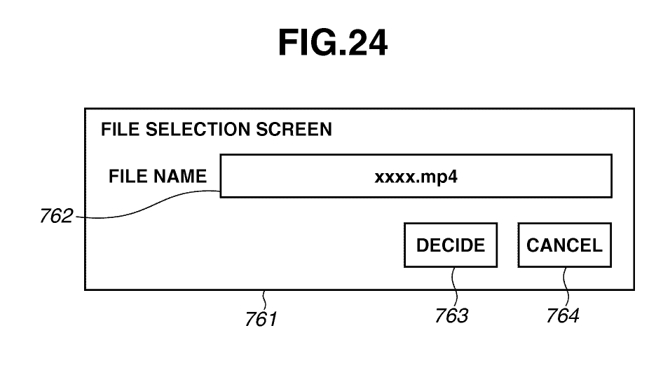

When it is determined that a character has not been input in the character string input area 731 (NO in step S3013), in step S3019, the electronic bulletin board information display unit 311 determines whether the reference file attachment button 736 has been pressed by user's instruction. When it is determined that the reference file attachment button 736 has been pressed (YES in step S3019), in step S302, the electronic bulletin board information display unit 311 displays a reference file path input screen illustrated in FIG. 24. Then, the reference file input unit 313 stores a reference file path input on the reference file path input screen. The reference file includes an image file, a moving image file, a document file, an audio file, and an electronic file such as the searching result stored by the search unit 314.

The reference file input unit 313 calculates coordinates (coordinates of reference file access button) of a position of displaying the reference file access button for referring to the reference file based on the coordinates of the position of displaying the electronic input form. In the present exemplary embodiment, the specifically calculated coordinates are at a position shifted from the coordinates of the electronic input form by (Δx2, 0).

The reference file input unit 313 transmits, as reference file information, the reference file path and information about the coordinates of the reference file access button to the server 400. During the transmission, the reference file input unit 313 includes a reference file identifier indicating that the file information to be transmitted belongs to a reference file information type to transmit it. The processing up to step S3020 has been described. The reference file access button is an image object selected for referring to the reference file based on a user's instruction.

In step S3021, the electronic bulletin board information display unit 311 hides the electronic input for, 730.

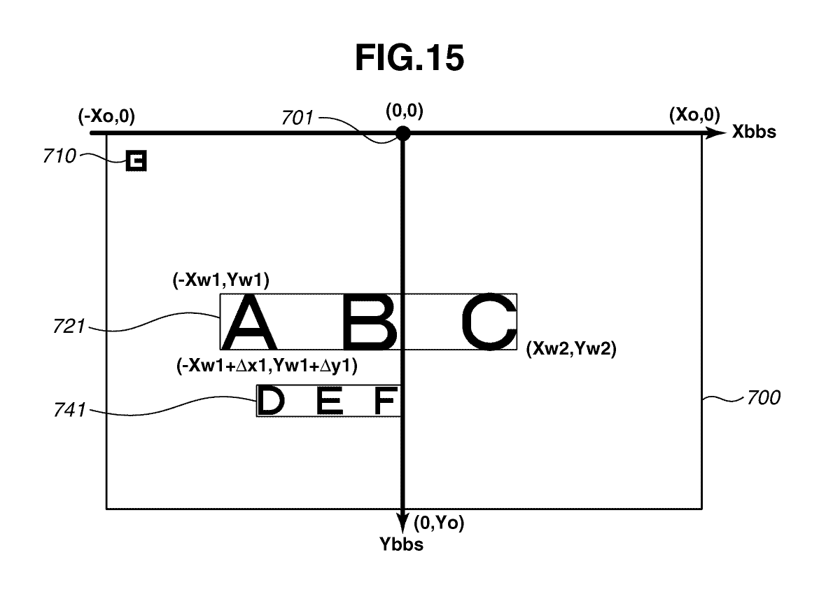

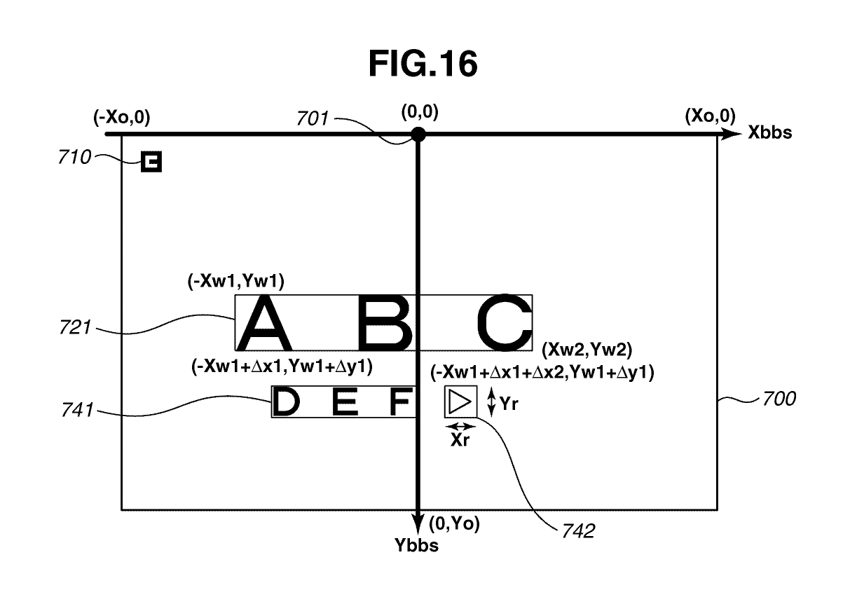

Then, in step S3022, the electronic bulletin board information display unit 311 displays an input result on the coordinates displaying the electronic input form 730. When the handwritten comment 721 is selected by user's instruction to display the electronic input form 730, if an input content in the electronic input form is an electronic comment, an electronic comment 741 is displayed. For example, when the handwritten comment 721 illustrated in FIG. 15 is selected, the electronic comment 741 (character string “DEF”) is displayed on the same coordinates (−Xw+Δx1, Yw1+Δy1) as those of the electronic input form 730. Further, When the handwritten comment 721 is selected by user's instruction to display the electronic input form 730, if an input content in the electronic input form is an attached file, a reference file access button 742 is displayed. For example, when the handwritten comment 721 illustrated in FIG. 15 is further selected, as illustrated in FIG. 16, the reference file access button 742 is displayed on coordinates (−Xw+Δx1+Δx2, Yw1+Δy1) shifted by a predetermined position from the coordinates where the electronic input form 730 is displayed.

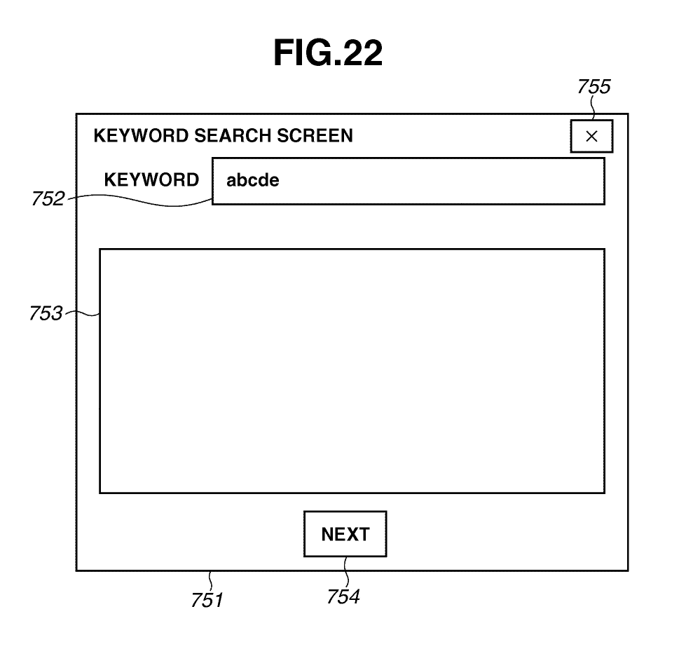

FIG. 22 illustrates a search engine screen 751.

On the search engine screen 751, the character string input in the character string input area 731 is displayed in a keyword section 752. A searching result is displayed in a search result section 753. A next button 754 is for displaying a searching result of a next page. A hide button 755 is for closing the search engine screen.

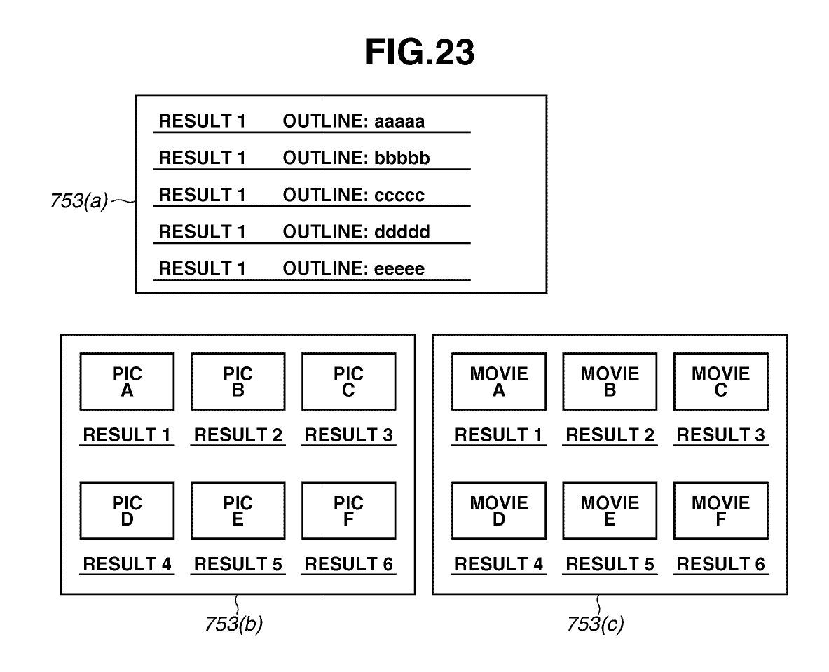

FIG. 23 illustrates the search result section 753.

FIG. 23 illustrates a keyword search result example 753(a), an image search result example 753(b), and a moving image search result example 754(c).

FIG. 24 illustrates a reference file path input screen load.

A reference file path input field 762 is for inputting a reference file to be attached. A decide button 763 is for deciding attachment of the reference file input in the reference file path input field 762. A cancel button 764 is for closing the reference file path input screen.

In the present exemplary embodiment, a reference file path is a path to a file stored in the storage unit 303 of the information terminal 300. However, when the file is uploaded from the information terminal 300 to the server 400 simultaneously with transmission of the reference file path, the following configuration can be employed. When the reference file path is transmitted to the server 400, the reference file input unit 313 uploads the storage unit 403 of the server 400, and converts the reference file path into a path to an uploading destination of the reference file to transmit it. Thus, since the reference file is uploaded to the server 400, and the path to the file is stored, the reference file can be referred to from any information terminal 300.

(Thread Information)

FIGS. 18A and 18B illustrate thread information managed by the thread management unit 413 in the server 400.

The thread management unit 413 manages a plurality of pieces of thread information. One piece of thread information is represented by a tree structure including one thread header and one or more pieces of comment information, or 0 or more pieces of reference file information.

A thread header 801 includes the following information.

Thread ID: thread ID is for uniquely identifying a thread.

Head comment ID: head comment ID indicates comment ID of comment information at a head of the thread.

Thread coordinates (Xthread): thread coordinates (Xthread) indicate X thread coordinates of thread information displayed on an electronic bulletin board coordinate system (Xbbs, Ybbs).

Thread coordinates (Ythread): thread coordinates (Ythread) indicate Y thread coordinates of thread information displayed on the electronic bulletin board coordinate system.

Thread size (XSIZEthread): thread size (XSIZEthread) indicates a size of the thread displayed on the electronic bulletin board coordinate system in an Xbbs axis direction.

Thread size (YSIZEthread): thread size (YSIZEthread) indicates a size of the thread displayed on the electronic bulletin board coordinate system in a Ybbs axis direction.

Comment information 802 includes the following information.

Comment ID: comment ID is for uniquely identifying a comment.

Parent comment ID: parent comment ID is comment ID of comment information that is a parent node of the comment. When the comment is a head comment, there is no parent node.

Child comment ID: child comment ID is comment ID of comment information that is a child node of the comment. Parent comment information can have a plurality of pieces of child comment information. The parent comment ID and the child comment ID included in the comment information are also referred to as comment parent information indicating a parent relationship of the comment information.

Reference file ID: reference file ID is reference file ID of a reference file associated with the comment information. The comment information can have a plurality of pieces of reference file information. Type: type is a comment identifier indicating which of a bitmapped image as a handwritten comment and a character string as an electronic comment a type of the comment information is.

Data: data is a bitmap file name in the case of handwritten comment information and character string data in the case of electronic comment information.

Comment coordinates (Xcom): comment coordinates (Xcom) indicate Xbbs coordinates of the comment information displayed on the electronic bulletin board coordinate system.

Comment coordinates (Ycom): comment coordinates (Ycom) indicate Ybbs coordinates of the comment information displayed on the electronic bulletin board coordinate system.

Comment size (XSIZEcom): comment size (XSIZEcom) indicates a size of the comment displayed on the electronic bulletin board coordinate system in the Xbbs axis direction.

Comment size (YSIZEcom): comment size (YSIZEcom) indicates a size of the comment displayed on the electronic bulletin board coordinate system in the Ybbs axis direction. The comment size (XSIZEcom) and the comment size (YSIZEcom) are used when the type of the comment information is a bitmap. When the type is a character string, a character string size is calculated from a character size defined on the server 400 side.

Superimposing target: superimposing target indicated whether to target the comment information for superimposed displaying. The server side can always be set beforehand as a superimposed displaying target, or comment information from head comment ID up to N pieces can be set as superimposed displaying targets. In comment information 805(b) described below referring to FIG. 18B, N=3 is set.

Reference file information 803 includes the following information.

Reference file ID: reference file ID is for uniquely identifying reference file information.

Parent comment ID: parent comment ID is comment ID of comment information that is a parent node of the reference file information.

Type: type indicates a type of the reference file information. There are such types as a moving image, an audio, a document, graphics, a uniform resource locator (URL), and a short cut. Data can be reproduced by an application corresponding to a type.

Data: data indicates a reference file path of the reference file information.

Access point coordinates (Xacc): access point coordinates (Xacc) indicate Xbbs coordinates of an access button of the reference file information displayed in the electronic bulletin board coordinate system. Access point coordinates (Yacc): access point coordinates (Yacc) indicate Ybbs coordinates of an access button of the reference file information displayed in the electronic bulletin board coordinate system. Access button size (XSIZEacc): access button size (XSIZEacc) indicates a size of the access button of the reference file information displayed on the electronic bulletin board coordinate system in the Xbbs axis direction.

Access button size (YSIZEacc): access button size (YSIZEacc) indicates a size of the access button of the reference file information displayed on the electronic bulletin board coordinate system in the Ybbs axis direction.

A thread 804 is an example of a tree structure of thread information. The thread 804 includes one thread header, five pieces of comment information, and three pieces of reference file information. Comment information of comment ID=3 has two pieces of child comment information, i.e., comment ID=4 and comment ID=5. Comment information of comment ID=4 has two pieces of reference file information, i.e., reference file ID=2 and reference file ID=3.

For example, the thread 804 includes a thread header 805(a), a comment information list 805(b), and a reference file list 805(c). Parent comment ID=0 means head comment information having no parent comment information. Child ID=0 means comment information of a tail end having no child comment information. Reference file ID=0 means having no reference file information. Superimposing target=1 means that data is a superimposing target. Superimposing target=0 means that data is not a superimposing target.

(Thread Management)

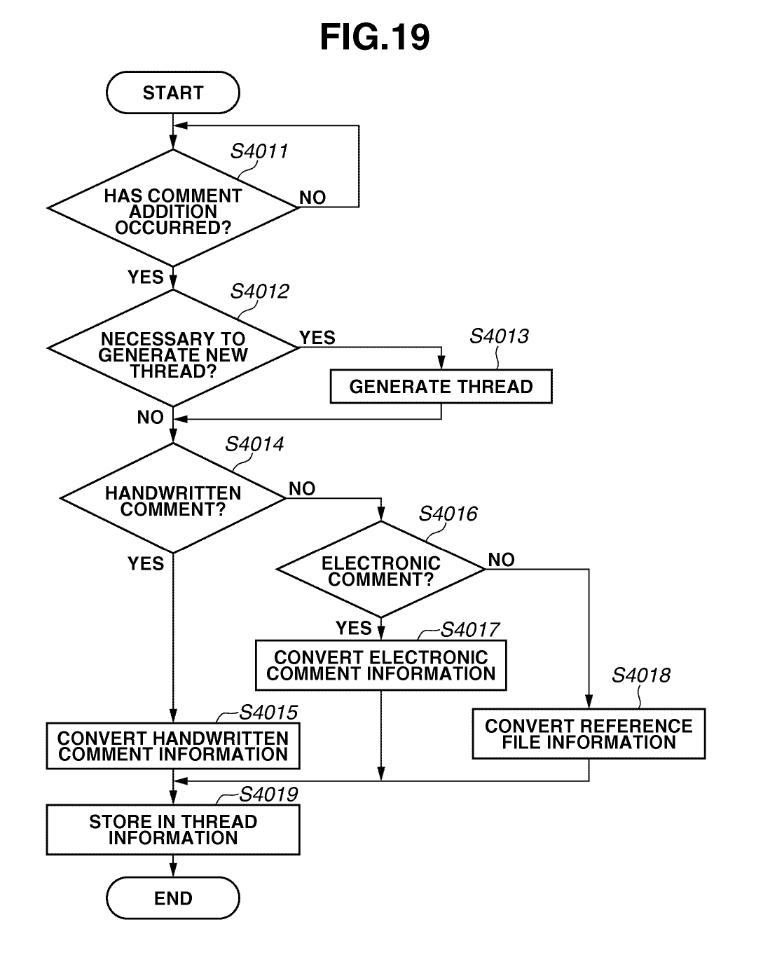

FIG. 19 illustrates thread management processing in the server 400.

In step S4011, the thread management unit 413 determines whether comment addition has occurred. Specifically, when it receives comment information (handwritten comment information or electronic comment information) or reference file information, the thread management unit 413 determines that comment addition has occurred.

When it is determined that comment addition has occurred (YES in step S4011), in step S4012, the thread management unit 413 determines whether it is necessary to generate a new thread. Specifically, when coordinate information included in the comment information does not indicate the inside of a display area of each comment information 802 or an area of the reference file access button of each reference file information 803 in the thread information, the thread management unit 413 determines that it is necessary to generate a new thread. When the coordinate information included in the comment information indicates the inside of the display area of each comment information or the area of the reference file access button in the thread information stored in the storage unit 303, the thread management unit 413 determines that it is unnecessary to generate any new thread.

When it is determined that it is necessary to generate a new thread (YES in step S4012), in step S4013, the thread management unit 413 generates a new thread by generating a new thread header 801. Processing executed by the thread management unit 413 thereafter concerns information of the newly generated thread information. When it is determined that it is unnecessary to generate a new thread (NO in step S4012), processing executed by the thread management unit 413 thereafter concerns information of the existing thread information.

Then, in step S4014, the thread management unit 413 determines whether the input comment information is handwritten comment information. Specifically, the comment type determination unit 411 determines whether the comment information is handwritten comment information by referring to a comment identifier included in the input comment information, and transmits a determination result to the thread management unit 413. Then, the thread management unit 413 determines whether the input comment information is handwritten comment information based on the received determination result. When it is determined that the input comment information is handwritten comment information (YES in step S4014), in step S4015, the thread management unit 413 converts the input comment information into a format of thread information so that the comment information can be thread-displayed as handwritten comment information.

When it is determined that the input comment information is not handwritten comment information (NO in step S4014), in step S4016, the thread management unit 413 determines whether the input comment information is electronic comment information. Specifically, the comment type determination unit 411 determines whether the comment information is electronic comment information by referring to the comment identifier included in the input comment information, and transmits a determination result to the thread management unit 413. Then, the thread management unit 413 determines whether the input comment information is electronic comment information based on the received determination result.

When it is determined that the input comment information is electronic comment information (YES in step S4016), in step S4017, the thread management unit 413 converts the input comment information into a format of thread information so that the comment information can be thread-displayed as electronic comment information.

When it is determined that the input comment information is not electronic comment information (NO in step S4016), since it is reference file information that has been input, in step S4018, the thread management unit 413 converts the reference file information into a format of thread information so that the reference file information can be thread-displayed.

In step S4019, the thread management unit 413 adds the comment information or the reference file information converted into the format of the thread information (802, 803 illustrated in FIG. 18A) to the thread information. Then, the thread management unit 413 updates the thread header to store the thread information in the storage unit 403.

The thread information managed by the thread management unit 413 may be read from the storage unit 403 of the server 400 by the information terminal 300. The original data stored in the storage unit 403 may also be read by the information terminal 300, and displayed on the display unit 304 after addition of thread information. In this case, the server 400 transmits the thread information and the original data 700 stored in the storage unit 403 to the information terminal 300. Then, the control unit 302 of the information terminal 300 displays the original data 700 in the electronic bulletin board coordinate system, and superimposes the thread information on the original data 700 to display it.

Specifically, the control unit 302 acquires comment information and reference file information used for displaying one thread by the thread header of the thread information. Then, based on data and types of the acquired comment information and the acquired reference file, the control unit 302 generates an image object of a bitmap, a character string, or a reference file access button. Further, the control unit 302 acquires coordinate information (comment coordinates, access button coordinates) of each of the comment information and the reference file information and size information (comment size, access point size). Then, based on the acquired coordinate information and the acquired size information, to superimpose the generated image object on the original data 700 to display it, the control unit 302 generates an image synthesizing the image object on the original data 700. Then, the control unit 302 displays the synthesized image on the display unit 304. Image data obtained by synthesis is an image maintaining a positional relationship of an input or displaying of each information when each information of the thread information (comment information and reference file information) is input, and displayed as one thread in a thread shape. Such displaying is referred to as thread displaying.

When the thread information (thread header 805(a), comment information 805(b), and reference file information 805(c)) illustrated in FIG. 18B is thread-displayed on the original data 700, a displayed image is as illustrated in FIG. 25A. That is, when the information terminal 300 reads the thread information together with the original data 700 to thread-display it, since there is no restriction on a size of a displayed screen, all pieces of the thread information are superimposed on the original data 700 to thread-display them. In such a case, the superimposing unit 315 thread-displays information of “superimposing target” of the comment information as “superimposing target”=1″ for all the pieces of thread information. Displaying of all or some (e.g., N pieces from heat comment) of the pieces of thread information can be switched based on a user's instruction.

(Superimposed Display)

In the electronic bulletin board system according to the present exemplary embodiment, the handwritten comment input in the paper document 10 is bitmapped. The bitmapped handwritten comment is displayed together with the original data 700 on the display unit 304 of the information terminal 300. Then, the user who has added handwritten comment to the handwritten comment or other users can add electronic comments via the information terminal 300.

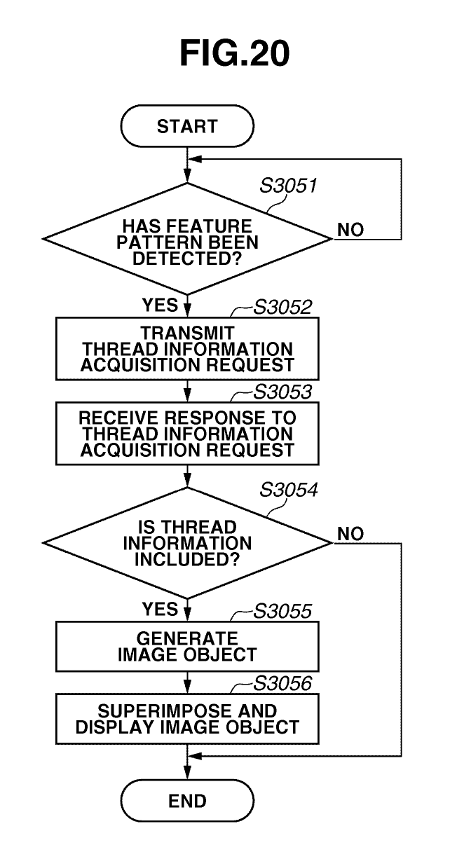

In such an electronic bulletin board system, the user who has added a handwritten comment to the paper document 10 may wish to read comments to the handwritten comment from other users. The user who has received the paper document 10 before addition of any handwritten comment may wish to immediately read handwritten comments or electronic comments that have been added by other users. To deal with such a use case, there is processing for displaying, when the image capturing unit 306 of the information terminal 300 captures an image of the paper document 10, an image formed by superimposing a handwritten comment or an electronic comment on the captured image on the display unit 304 at real time. This processing will be described referring to FIGS. 20, 21, 25A, and 25B.

FIG. 20 illustrates processing of the information terminal 300 concerning superimposed displaying. By this processing, the information processing terminal 300 can superimpose the thread information stored in the storage unit 303 on the image of the paper document 10 captured by the image capturing unit 306 and displayed on the display unit 304 to display it based on a position of a feature pattern on the image of the paper document 10.

In step S3051, the image capturing unit 306 captures the image of the paper document 10, and transmits the captured image (3001 in FIG. 25B) to the superimposing unit 315 of the control unit 302. Then, the superimposing unit 315 of the control unit 302 searches for a feature pattern (pattern 110 in FIG. 25B) in the captured image 3001 to determine whether any feature pattern has been detected. The feature pattern is for enabling a correlation to be set between a paper surface coordinate system and an electronic bulletin board coordinate system when the pattern is detected. Accordingly, a bitmapped image of comment information or an image object such as a character string or a reference file access button managed in the electronic bulletin board coordinate system can be superimposed on an appropriate position in the captured image 3001 to be displayed. The feature pattern employed in the present exemplary embodiment is represented by the pattern 110 illustrated in FIG. 25B. However, any feature pattern visible or invisible to people can be used. To detect an identified feature pattern from the captured image 3001, in the present exemplary embodiment, for example, an augmented reality technology is used.

When it is determined that the feature pattern has been detected (YES in step S3051), in step S3052, the superimposing unit 315 transmits a thread information acquisition request including information of the feature pattern (feature pattern information) to the server 400.

Then, in step S3053, the superimposing unit 315 receives information as a response to the feature pattern information transmitted in step S3052 from the server 400.

Then, in step S3054, the superimposing unit 315 determines whether the information received in step S3053 includes any thread information. In other words, the superimposing unit 315 determines whether any thread information has been received.

When it is determined that thread information has been received (YES in step S3054), in step S3055, the superimposing unit 315 generates, for each comment information 802 of the received thread information, an image object of comment information to be superimposed and displayed based on information of a “superimposing target” included in the comment information 802. When generating the image object of the comment information, the superimposing unit 315 generates an image object of a reference file access button for reference file information having comment ID of the comment information to be superimposed and displayed as parent comment ID. For reference file information having comment ID of comment information not to be displayed in a superimposed manner as parent comment ID, the superimposing unit 315 does not generate any image object of a reference file access button, nor target the information for superimposition. Thus, the image object is generated in a position where a positional relationship between the comment information and the file information can be maintained based on each coordinate information in the thread information. In other words, as illustrated in FIG. 25B, a handwritten comment 721, electronic comments 741 and 743, and a reference file access button 742 are arranged in a thread shape.

Then, in step S3056, the superimposing unit 315 superimposes the generated image object on a position based on a detection position of the feature pattern on the image captured by the image capturing unit 306b to thread-display it. For example, the superimposing unit 315 thread-displays the generated image object so that a head comment of the image object can be displayed on coordinates of the detection position of the feature pattern. Further, for example, the superimposing unit 315 thread-displays the generated image object so that the head comment of the image object can be displayed on a coordinate position offset by a predetermined distance from the coordinates of the detection position of the feature pattern. Alternatively, the superimposing unit 315 thread-displays the generated image object so that the head comment of the image object can be displayed on a position calculated based on a coordinate position of the image object in the electronic bulletin board coordinate system and the detection position of the feature pattern.

When it is determined that no thread information has been received (NO in step S3054), the superimposing unit 315 does not generate any image object to be superimposed.

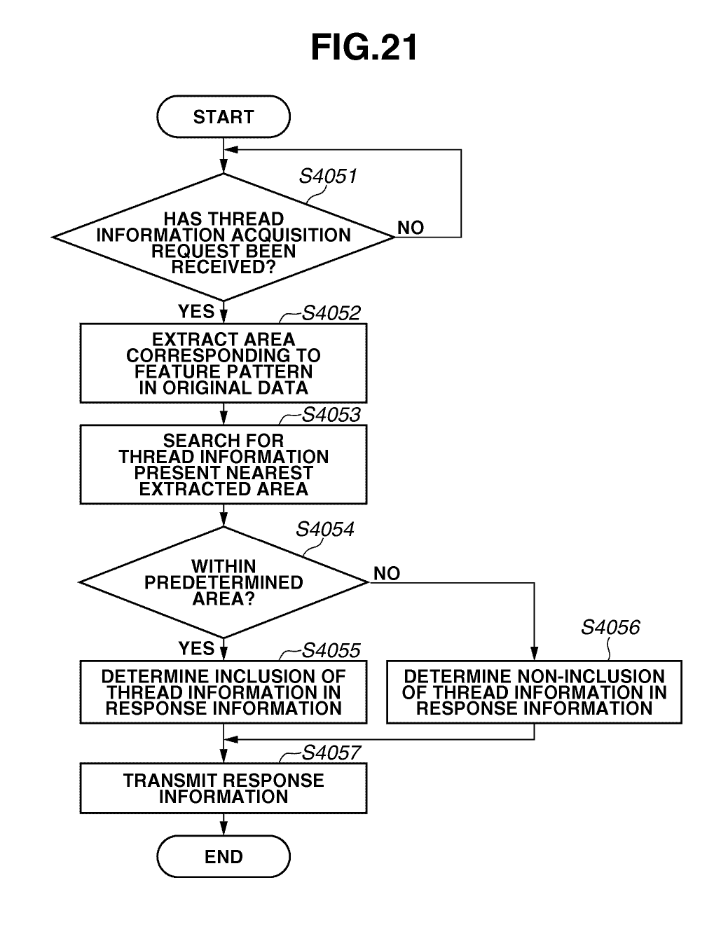

FIG. 21 illustrates processing of the server 400 concerning superimposed displaying.

In step S4051, the control unit 402 determines whether the thread information acquisition request of step S3052 has been received from the information terminal 300. The thread information acquisition request includes the information of the feature pattern detected by the superimposing unit 315.

When it is determined that the thread information acquisition request has been received (YES in step S4051), in step S4052, the feature extraction unit 415 of the control unit 402 extracts, from the original data 700, an area in the original data 700 corresponding to the received feature pattern (pattern 110). The area in the original data 700 corresponding to the feature pattern (pattern 110) is an image area of a coordinate position of the pattern 710 at the feature pattern in the original data 700 that is an origin of the pattern 110.

Then, in step S4053, the control unit 402 searches, based on the thread coordinates of the thread header, for thread information closest to the coordinate position of the area extracted in step S4052 in the electronic bulletin board coordinate system among the plurality of pieces of the thread information managed by the thread management unit 413.

Then, in step S4054, the control unit 402 determines whether an area of the closest thread information is within a predetermined distance from the area of the feature pattern (pattern 710). Specifically, the control unit 402 determines whether a distance between thread coordinates of a thread header included in the closer thread information and the coordinates of the area extracted in step S4052 in the electronic bulletin board coordinate system is within a predetermined threshold value.

When “within” is determined (YES in step S4054), in step S4055, the control unit 402 determines inclusion of the thread information that is a searching result in step S4053 as a response to the thread information acquisition request received in step S4051. When “not within” is determined (NO in step S4054), in step S4056, the control unit 402 determines non-inclusion of the thread information as a response to the thread information acquisition request received in step S4051.

Then, in step S4057, the control unit 402 transmits the information as the response to the thread information acquisition request to the information terminal 300 as determined in step S4055 or S4056.

Thus, by executing the processing illustrated in FIGS. 20 and 21, a handwritten comment, an electronic comment, or a reference file access button can be thread-displayed for the captured image 3001 captured by the image capturing unit 306 as illustrated in FIG. 25B. As a result, the user can easily acquire an electronic comment added to a handwritten comment only by capturing the image of the paper document 10, and easily understand a relationship between the comments because of thread displaying.

The processing flow illustrated in FIGS. 20 and 21 is executed when the information terminal 300 superimposes the thread information on the image captured by the image capturing unit 306, and the image displayed in FIG. 25B is displayed on the display unit 304. In this case, the information terminal 300 can include a mode selection unit for selecting a display mode of superimposing the thread information on the original data 700 to display it as illustrated in FIG. 25A or a display mode of superimposing the thread information on the captured image 3001 to display it as illustrated in FIG. 25B.

In the exemplary embodiment, the method for inputting the handwritten comment information is based on the coordinate calculation using the electronic pen 100 that generates ultrasonic waves. However, another method can be used. Specifically, data is written on a special sheet on which a predetermined dot pattern has been printed by an electronic pen, and the dot pattern is read according to a locus by an image capturing unit included in the electronic pen. The server, which has stored the dot pattern information of the special sheet, generates a bitmapped image of a handwritten comment in the electronic bulletin board coordinate system based on locus information transmitted from the electronic pen.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-055001 filed Mar. 12, 2012, which is hereby incorporated by reference herein in its entirety.

What is claimed is:

1. An information processing system, comprising:
a handwritten comment acquisition unit configured to acquire, as an image object, handwritten comment information for a print product obtained by printing an original image;
a selection unit configured to select the handwritten comment information based on a user's instruction;
an electronic comment acquisition unit configured to acquire electronic comment information for the handwritten comment information selected by the selection unit;
a thread management unit configured to manage, as thread information, the handwritten comment information selected by the selection unit and the electronic comment information acquired by the electronic comment acquisition unit in association with each other; and
a display unit configured to superimpose the thread information managed by the thread management unit on the original image to display the thread information in a thread shape.

2. The information processing system according to claim 1, wherein the display unit displays a plurality of pieces of thread information managed by the management unit when the thread information is superimposed on the original image, and displays single thread information managed by the management unit when the thread information is superimposed on an image obtained by capturing an image of the print product.

3. The information processing system according to claim 1, wherein the handwritten comment acquisition unit acquires the handwritten comment information together with coordinate information of the handwritten comment information,
wherein the display unit displays the handwritten comment information in a position based on the coordinate information of the handwritten comment information, and displays, when the displayed handwritten comment information is selected by the selection unit, an electronic input form for acquiring the electronic comment information in a position based on a display position of the selected handwritten comment information,
wherein the electronic comment acquisition unit acquires, with a display position of the electronic input form set as coordinate information of the electronic comment information, the electronic comment information together with the coordinate information of the electronic comment information via the electronic input form, and
wherein the display unit displays, based on the handwritten comment information and the coordinate information of the electronic comment information, the thread information in a thread shape.

4. The information processing system according to claim 3, wherein the display unit displays, when the displayed handwritten comment information is selected by the selection unit, the electronic input form in a position offset by a predetermined distance from the display position of the selected handwritten comment information, to display the electronic input form in a position where a display area of the handwritten comment information and a display area of the electronic input form do not overlap each other.

5. The information processing system according to claim 3, wherein the electronic input form includes a character string input area for receiving a character string input as electronic comment information, and a reference file input area for receiving an attached reference file input as reference file information.

6. The information processing system according to claim 1, wherein the selection unit selects the handwritten comment information by selecting a display area of the handwritten comment information in the image displayed by the display unit based on a user's instruction, and selects the electronic information by selecting a display area of the electronic comment information based on a user's instruction,
wherein the display unit displays an electronic input form when the selection unit selects a display area including none of the display areas of the handwritten comment information and the electronic comment information displayed by the display unit based on a user's instruction,
wherein the electronic comment acquisition unit acquires electronic comment information input via the electronic input form,
wherein the thread management unit generates new thread information, and adds the acquired electronic comment information to the new generated thread information to manage the information,
wherein the display unit displays the electronic input form when the selection unit selects a display area including one of the display areas of the handwritten comment information and the electronic comment information displayed by the display unit based on a user's instruction,
wherein the electronic comment acquisition unit acquires electronic comment information input via the electronic input form, and
wherein the thread management unit adds, without generating any new thread information, the acquired electronic comment information to thread information where handwritten comment information or electronic comment information corresponding to the display area selected by the selection unit to manage the information.

7. The information processing system according to claim 1, wherein the thread information includes, for the handwritten comment information and the electronic comment information, comment parent-child information indicating a comment parent-child relationship and comment coordinates displaying a comment.

8. The information processing system according to claim 1, wherein the display unit displays, when the thread information managed by the thread management unit is thread-displayed on an image obtained by capturing an image of the print product, a part of the handwritten information or the electronic comment information included in the thread information, and displays, when the thread information managed by the thread management unit is thread-displayed on the original image, all the handwritten information or the electronic comment information included in the thread information.

9. The information processing system according to claim 1, wherein the display unit detects a feature pattern from an image obtained by capturing an image of the print product, and superimposes thread information of an area corresponding to the detected feature pattern on the image to display the information.

10. An information processing method, comprising:
acquiring, as an image object, handwritten comment information for a print product obtained by printing an original image;
selecting the handwritten comment information based on a user's instruction;
acquiring electronic comment information for the selected handwritten comment information;
managing, as thread information, the selected handwritten comment information and the acquired electronic comment information in association with each other; and
superimposing the managed thread information on the original image to display the thread information in a thread shape.

11. A non-transitory computer-readable storage medium storing a program that causes at least one computer to execute an information processing method, the information processing method comprising:
acquiring, as an image object, handwritten comment information for a print product obtained by printing an original image;
selecting the handwritten comment information based on a user's instruction;
acquiring electronic comment information for the selected handwritten comment information;
managing, as thread information, the selected handwritten comment information and the acquired electronic comment information in association with each other; and
superimposing the managed thread information on the original image to display the thread information in a thread shape.

12. An information processing apparatus transmitting information to a display unit which is different from the information processing apparatus, comprising:
a reception unit configured to receive handwritten comment information for a print product obtained by printing an original image;
a handwritten comment acquisition unit configured to convert the handwritten comment information received by the reception unit into an image object;
an electronic comment acquisition unit configured to acquire electronic comment information for the handwritten comment information selected based on a user's instruction;
a thread management unit configured to manage, as thread information, the handwritten comment information acquired by the handwritten comment acquisition unit and the electronic comment information acquired by the electronic comment acquisition unit in association with each other; and
a transmission unit configured to transmit the thread information managed by the thread management unit to the display unit configured to superimpose the thread information on the original image to display the thread information in a thread shape.
